(19) United States
(12) Patent Application Publication
(10) Pub. No.: US 2005/0105771 A1
(43) Pub. Date: May 19, 2005

(54) Object detection apparatus and method

(76) Inventors: Shinichi Nagai, Saitama (JP); Hiroshi Tsujino, Saitama (JP); Tetsuya Ido, Saitama (JP); Takamasa Koshizen, Saitama (JP); Koji Akatsuka, Saitama (JP); Hiroshhi Kondo, Saitama (JP); Atsushi Miura, Saitama (JP)

Correspondence Address: FENWICK & WEST LLP, SILICON VALLEY CENTER, 801 CALIFORNIA STREET, MOUNTAIN VIEW, CA, 94041, US

(21) Appl. No.: 10/930,566

(22) Filed: Aug. 30, 2004

(30) Foreign Application Priority Data
Sep. 2, 2003 (JP) 2003-310542

(51) Int. Cl. G06K 9/00; G06K 9/46; G06K 9/62

(52) U.S. Cl. 382/103; 382/190; 382/157

(57) ABSTRACT

The object detection apparatus according to the invention detects an object based on input images that are captured sequentially in time in a moving unit. The apparatus generates an action command to be sent to the moving unit, calculates flow information for each local area in the input image, and estimates an action of the moving unit based on the flow information. The apparatus calculates a difference between the estimated action and the action command and then determines a specific local area as a figure area when such difference in association with that specific local area exhibits an error larger than a predetermined value. The apparatus determines presence/absence of an object in the figure area.

### TECHNICAL FIELD

The present invention relates to an object detection apparatus for detecting an object in an image based on the image that is captured by an autonomously-moving unit.

### BACKGROUND OF THE INVENTION

Some techniques for detecting objects in captured images based on visual images are known in the art. For example, there is a method for calculating optical flows from captured sequential images and detecting a part of image corresponding to an object within area having same motion components. Since this can easily detect a moving object in the image, many object detection apparatus employs such method (for example, Japanese unexamined patent publication (Kokai) No.07-249127)

However, when an imaging device for capturing images is moving (for example, when the imaging device is mounted onto an automobile or the like), it would be difficult to detect the moving object in the image accurately because some optical flows associated to the self-motion of the device is generated in the image. In such cases, if a motion field of the entire view associated to the self-motion are removed from the optical flows, the moving object in the image may be detected more accurately. For example, in Japanese unexamined patent publication No.2000-242797, a motion detection method is disclosed where a variable diffusion coefficient is used when detecting optical flows in the image by means of a gradient method. According to this method, the diffusion coefficient is not fixed as in the conventional arts but compensated under some conditions, thereby noise resistance may be improved and differential of optical flows around object boundaries may be emphasized.

According to the method mentioned above, optical flows of the moving object, which is detected relatively easily, may be calculated accurately. However, when a stationary object on a stationary background is observed from a self-moving unit, it is difficult to segregate optical flows of the stationary object from that of the background. In this case, since the stationary object on the stationary background is recognized as a part of the background, optical flows are not emphasized and therefore the stationary object cannot be detected accurately.

Therefore, there is a need for an object detection apparatus and method capable of detecting stationary objects accurately based on images captured by a self-moving unit.

### SUMMARY OF THE INVENTION

The present invention provides an apparatus which enables an autonomously-moving unit (for example, a robot or a self-traveling vehicle) that moves autonomously based on information it obtains regarding the surrounding environment determine whether the condition of the surrounding environment is such abnormality that cannot be managed by the moving unit, determine whether or not any object exists around the moving unit, or, when an object exists around the moving unit, determine what the object is.

According to one aspect of the present invention, there is provided an object detection apparatus for detecting an object based on input images that are captured sequentially in time by the a moving unit. The apparatus has an action generating section for generating an action command to be provided to the moving unit. The apparatus includes a local-image processor for calculating flow information for each local area in the input image. The apparatus also includes a figure-ground estimating section for estimating an action of the moving unit based on the flow information. The estimating section calculates difference between the estimated action and the action command and then determines a figure area that is a local area where the difference is larger than a predetermined value. The apparatus includes an object presence/absence determining section for determining presence/absence of an object in the figure area.

The apparatus further includes an object recognizing section for recognizing an object when an object is determined to exist in the figure area.

The figure-ground estimating section estimates the action of the moving unit by utilizing a result of learning the relation between the flow information for each local area and the action of the moving unit carried out in advance. Such relation can be established through a neural network.

The figure-ground estimating section propagates back the difference between the estimated action and the action command by using an error back-propagation algorithm to determine the image area that causes the error. The figure-ground estimating section determines that an abnormality has occurred in the moving unit or in the environment surrounding the moving unit when the image area causing the error exceeds a predetermined threshold value. Besides, the figure-ground estimating section is structured to remove from the flow information of each local area the area causing the difference between the estimated action and the action command. The estimating section estimates again an action of the moving unit based on the remaining flow information.

The object presence/absence determining section removes high-frequency components from the frequency components of the images in the figure area and compares the images to determine presence or absence of continuity, which is a measurement of evaluating succession of an object in the images. The determining section determines that an object is included in the figure areas when continuity is determined to exist.

The present invention utilizes the action command issued to the moving unit to segregate the captured image between the “ground” area that is consistent with the action command and the “figure” area that is not consistent, and to segregate such figure areas as a candidate area where an object may exist. Accordingly, an object can be detected without prior knowledge on the object to be detected.

Besides, accuracy of estimation of the self-action is enhanced because the action is estimated based only on the image of the “ground” area. Since the “ground” area can be also segregated very precisely, not only a moving object but also a stationary object in the image can be detected.

The object is detected by utilizing the spatial frequency components with the phase elements removed. Such spatial frequency elements have a characteristic of continuity that they never change in a short time period. Therefore, the present invention can realize a robust object detection that is hardly influenced by noises.

### BRIEF DESCRIPTION OF THE DRAWINGS

FIG. 1 is a block diagram of an object detection apparatus according to one embodiment of the present invention.

FIG. 2 is a flowchart of a process in a local area image processor.

FIG. 3 is a diagram illustrating a local area.

FIG. 4 is a diagram illustrating an example of a local optical flow field (LOFF).

FIG. 5 is a block diagram illustrating detail of a process in a figure area estimating section.

FIG. 6 is a flowchart of a process in a figure area estimating section.

FIG. 7 is a diagram illustrating a concept of a process in neural network.

FIG. 8 is a diagram illustrating an input-output relation of elements of a neural network.

FIG. 9 is a flowchart of a process in an object presence/absence determining section.

### DESCRIPTION OF THE PREFERRED EMBODIMENTS

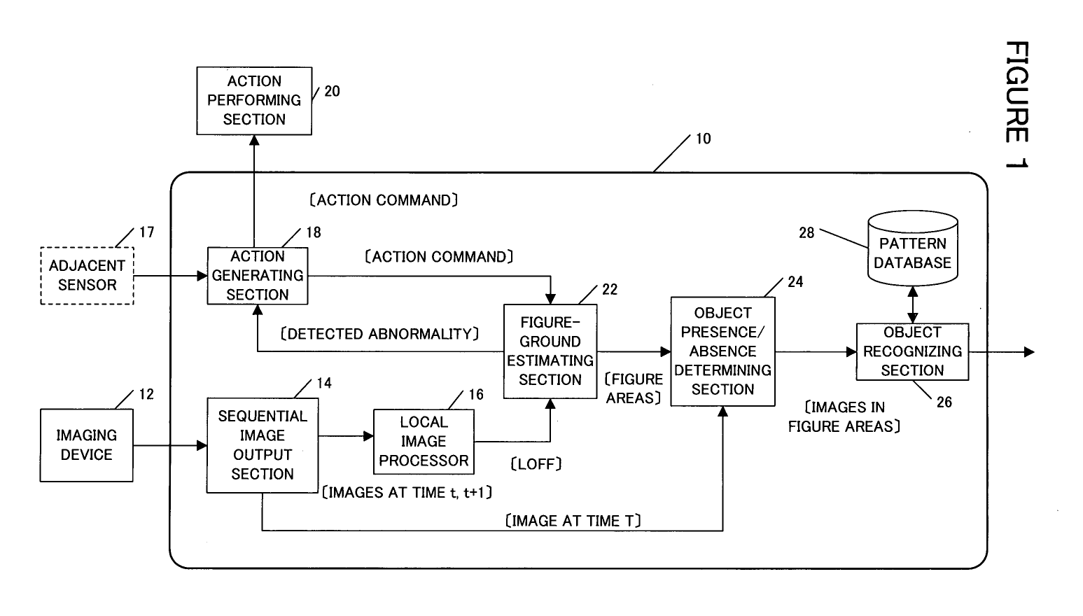

FIG. 1 shows a block diagram of an object detection apparatus 10 according to one embodiment of the present invention. The object detection apparatus 10 constantly receives sequential images that are captured in the direction of travel at predetermined time intervals by an imaging device 12, such as a CCD camera, mounted on a moving unit such as an autonomously-traveling vehicle. The apparatus 10 then detects and recognizes an object in the images.

The object detection apparatus 10 may be implemented by, for example, a microcomputer having a CPU for executing various computations, a RAM for temporarily storing computation results, a ROM for storing computer programs and data including learning results and an input/output interface for inputting/outputting data. The object detection apparatus 10 may be mounted on the moving unit together with an imaging device 12. In an alternative embodiment, images captured by the imaging device 12 mounted on the moving unit may be transmitted to a computer outside the moving unit via any communication means, where the object detection process of the invention is performed. In FIG. 1, the object detection apparatus 10 is illustrated with some functional blocks. A part of or all of the functional blocks may be implemented by either software, firmware or hardware.

The present invention is based on the following hypothesis. A human brain of a person has a map that associates the actions taken by the person with the changes of environmental information obtained by the person as a result of each action. When the correspondence between the action taken by the person and the obtained environmental information is different from that of the map, the person determines that the situation is abnormal. Therefore, in this embodiment, a learning map is first prepared in which the correspondence between actions taken by an autonomously-moving unit and the environmental information calculated based on the captured images has been learned. This map will be hereinafter referred to as a “state-action map”. An action that is actually taken by the autonomously-moving unit is compared with the action that is estimated from the state-action map. When the error (difference) is equal to or larger than a predetermined value, the environmental information is segregated and classified into “ground” and “figure” areas. The “ground” represents the environmental information that is consistent with the action estimated from the map and the “figure” represents the environmental information that is not consistent. Relative to the “figure” areas, this embodiment performs an abnormality detection process and an object detection/recognition process.

Functional blocks of FIG. 1 will now be described. Items enclosed with parentheses in FIG. 1 indicate information contents to be communicated among the functional blocks.

Based on an objective of the autonomously-moving unit which is assigned in advance to the moving unit (for example, go to a predetermined destination, move all around within a certain space and so on), an action generating section 18 chooses an appropriate action at that time from alternative actions (for example, a moving direction such as go straight, turn left, turn right or the like, a moving speed and so on) which can be performed by the autonomously-moving unit. The section 18 then sends an action command to an action performing section 20.

The alternative actions are the same as those in the map (state-action map) held by a figure-ground estimating section 22. The map associates flow information obtained from a local image processor 16 with respective actions that can be taken by the autonomously-moving unit.

The action generating section 18 may issue an appropriate command (for example, stop the moving unit) to the action performing section 20 when an abnormality is detected by the figure-ground estimating section 22 as to be described later. The action generating section 18 may select an action based on the information provided by a sensor 17 that captures information on the areas adjacent to the autonomously-moving unit.

An imaging device 12 captures sequential images in the direction of travel of the autonomously-moving unit at predetermined time intervals. A sequential image output section 14 outputs the images provided by the imaging device 12 to the local image processor 16 as a train of several sequential images, for example, as a train of two sequential images at time t−1 and time t. The section 14 sends the image at time t to an object presence/absence determining section 24.

The local image processor 16 subdivides the sequential images at time t−1 and time t into local areas each having an equal size and calculates a local change within the images (that is, a LOF to be described later), which is a change in each local area caused by the action of the moving unit during the period from time t−1 to time t. The local image processor 16 outputs the entire LOFs as a local optical flow field (LOFF).

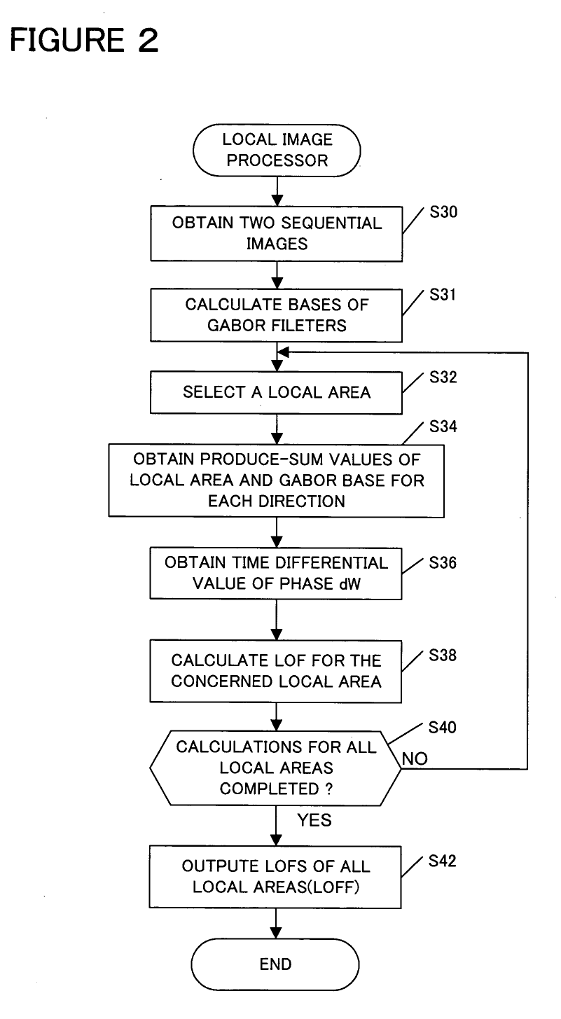

FIG. 2 is a flowchart of process in the local area image processor 16. The local area image processor 16 receives two sequential images from the sequential image output section 14 (S30). In the following description, intensity values of a pixel at coordinates (x,y) in the images captured at time t and t+1 are expressed as Img (x,y,t) and Img (x,y,t+1), respectively. The coordinates (x,y) is orthogonal coordinates with the upper-left corner of the image being an origin point. The intensity value takes on integer values from 0 to 255.

The local area image processor 16 calculates bases of Gabor filters for both positive and negative directions along both x direction and y direction of the image by following equations (S31).

$$Gs ( x , y ) = 2 \sqrt{\frac{π}{4.4 {a}^{2}}} sin ( \frac{2 π x}{a} ) exp ( - \frac{{π}^{2} {r}^{2}}{4.4 {a}^{2}} ) \\ Gc ( x , y ) = 2 \sqrt{\frac{π}{4.4 {a}^{2}}} cos ( \frac{2 π x}{a} ) exp ( - \frac{{π}^{2} {r}^{2}}{4.4 {a}^{2}} ) \qquad ( 1 )$$

where Gs(x,y) represents a sine component of the basis of Gabor filter, and Gc(x,y) represents a cosine component of the basis of Gabor filter. (x,y) in equations (1) is based on coordinates with the center of the image as an origin point (x, y and r in equation (1) have a relationship of r=(x²+y²)^{1/2}), which is different from the coordinates (x,y) of the intensity value Img (x,y,t). “a” is a constant and set to a value such that filter sensitivity increases with “a” as a center. Applying two other equations created by rotating the axis of each equation in (1) by 90 degrees, the bases of the Gabor filters of both positive and negative directions along both x and y directions (that is, upward, downward, leftward and rightward direction of the image) are acquired.

Gabor filters have similar properties to a receptive field of human being. When an object moves in the image, features of optical flows appear more clearly in the periphery of the image than the central part of the image. In this regard, properties of the Gabor filters (such as size of the receptive field, i.e., size of the filter (window)) and spatial frequency may be optimized according to the coordinates (x,y) in the image.

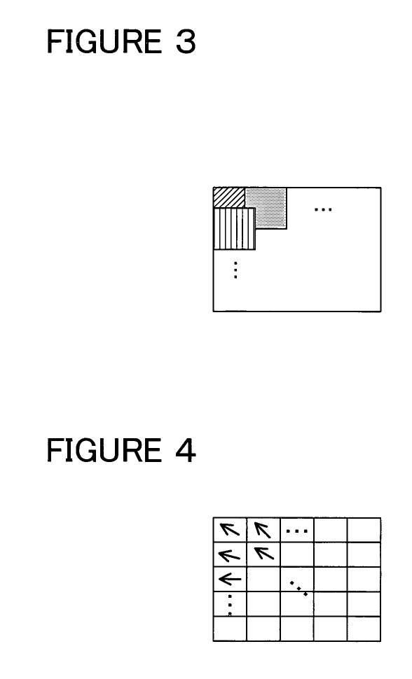

The local area image processor 16 selects one local area from the train of images captured at time t and t+1 (S32). The “local area” herein refers to a small area which is a part of the image for calculating local optical flows in the image. Each local area is the same in size. In one example, the size of a whole image captured by the imaging device 12 is 320×240 pixels and the size of each local area may be set to 45×45 pixels. An example of the positional relationships between the whole image and local areas is shown in FIG. 3. In this figure, an outer rectangle represents the whole image and smaller hatched squares represent the local areas respectively. It is preferable that each local area is positioned so that adjacent local areas overlap each other as shown in FIG. 3. Overlapping local areas in such a way enables pixels around the boundaries of local areas to be included in two or more local areas, thereby more accurate object detection may be realized. However, since the processing speed decreases as overlapping width become wider, an appropriate value should be selected as the overlapping width.

At first, the local area image processor 16 selects the local area located at the upper left corner of the image.

The local area image processor 16 performs product-sum operation of each pixel Img (x,y,t) and Img (x,y,t+1) included in the selected local area and the bases of Gabor filters. Product-sum values xₜ, xₜ₊₁, yₜ, and yₜ₊₁ for all pixels in the given local area are calculated by following equations (S34).

$$\begin{matrix}{x}_{t} = {\sum }_{x , y} Gs ( x , y ) \times Img ( x , y , t ) \\ {y}_{t} = {\sum }_{x , y} Gc ( x , y ) \times Img ( x , y , t ) \\ {x}_{t + 1} = {\sum }_{x , y} Gs ( x , y ) \times Img ( x , y , t + 1 ) \\ {y}_{t + 1} = {\sum }_{x , y} Gc ( x , y ) \times Img ( x , y , t + 1 )\end{matrix} \qquad ( 2 )$$

Then, using these product-sum values, time differential value of phase “dw”, weighted with a contrast (x²+y²), is calculated by following equation (S36).
dw={(xₜ+xₜ₊₁)×(yₜ₊₁−yₜ)−(yₜ+yₜ₊₁)×(xₜ₊₁−xₜ)}/2 (3)

By performing calculations in steps S34 and S36 using the bases of Gabor filters along four directions of upward, downward, leftward and rightward, the components of those four directions of the optical flows are calculated. In other words, dw values in the four directions are calculated for one selected local area.

Each calculation of Equation (1) through Equation (3) is performed respectively using the bases of Gabor filters for four directions, that is, both positive and negative directions along both x and y directions, so that the components of the four directions of the optical flows for the selected local area can be calculated. An average of these four vectors or the vector having the largest absolute value is regarded as an optical flow of the selected local area, which is referred to as a “LOF (local optical flow)” (S38).

Once the calculation for one local area is completed, the local area image processor 16 selects the next local area and repeats the above-described steps S32 through S38 for all of the remaining local areas (S40). When the calculations of the LOF for all local areas are completed, all of the LOFs (LOFF) are output to the figure-ground estimating section 22 (S42). An example of the LOFF is shown in FIG. 4. Each cell in FIG. 4 corresponds to one local area. A direction of each arrow in FIG. 4 indicates the LOF for each local area. It should be noted that, in actual applications, the directions and the magnitudes of the LOFs are replaced by appropriate numeral values although the directions in FIG. 4 are represented by the arrows for a simple illustration purpose.

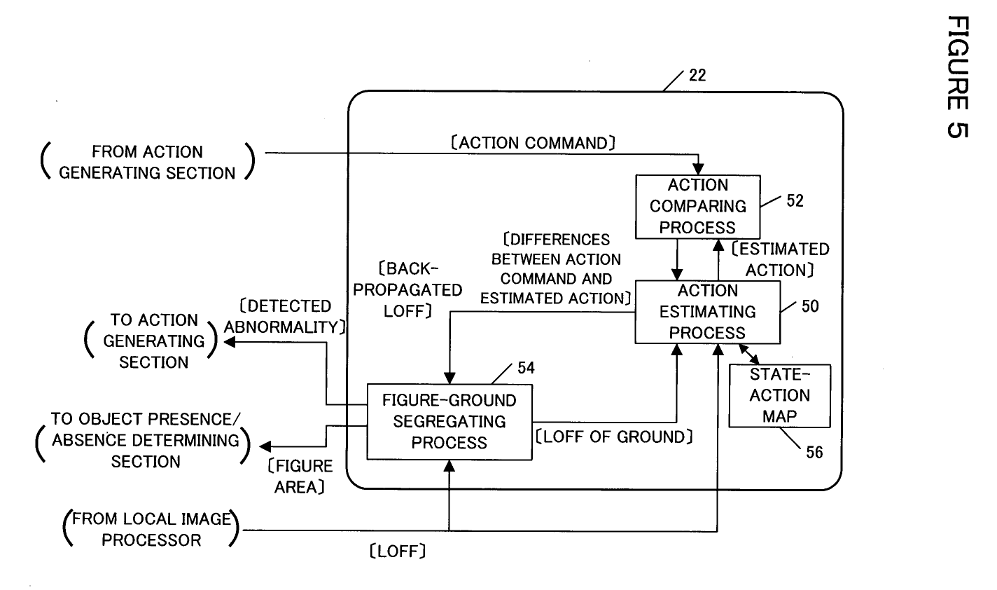

Now, the figure-ground estimating section 22 will be described. FIG. 5 illustrates the function of the figure-ground estimating section 22 in details. The figure-ground estimating section 22 uses the state-action map 56 to estimate the action being taken by the autonomously-moving unit based on the environmental information which is the LOFF in this embodiment (an action estimating process 50). It compares the estimated action with the action command that is issued by the action generating section to obtain a difference between them (an action comparing process 52). It uses the state-action map 56 again to identify, from the LOFF, the local areas causing the difference. The figure-ground estimating section 22 segregates the identified local areas and classifies them into the “figure” areas which are not consistent with the action of the moving unit and the other areas as the “ground” areas (a figure-ground segregating process 54).

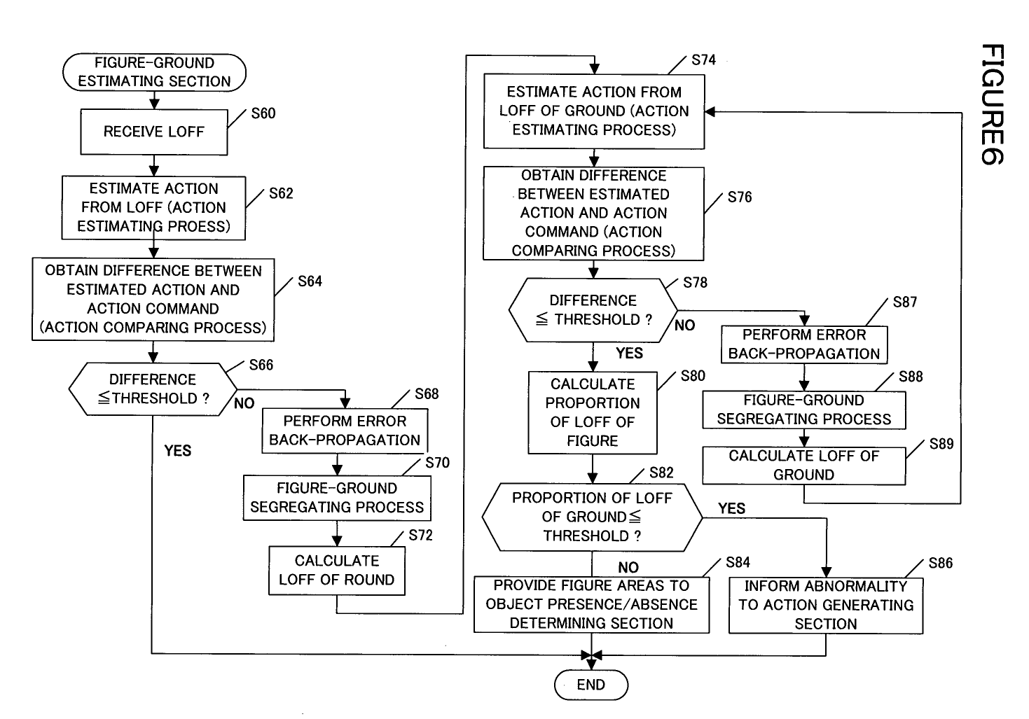

Referring to FIG. 6, details of the process by the figure-ground estimating section 22 will be described.

Receiving the LOFF from the local area image processor 16, the figure-ground estimating section 22 estimates an action corresponding to the input LOFF (S62). In doing so, the section 22 uses the state-action map in which the LOFF and the actions have been associated with each other.

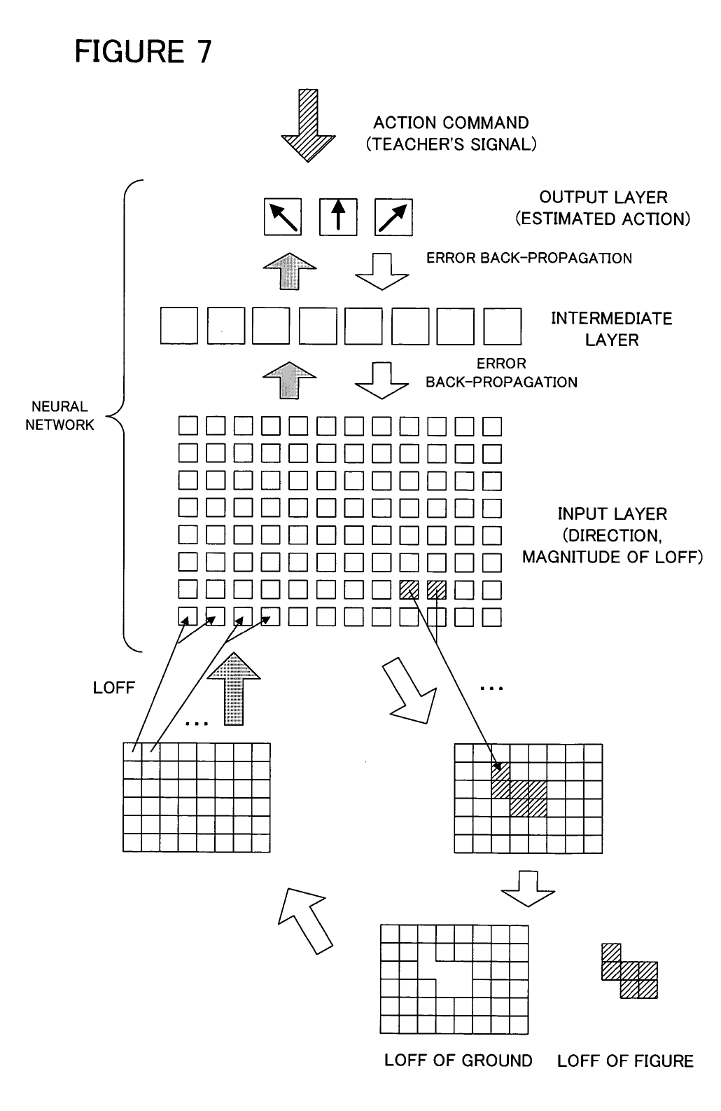

In this embodiment, the state-action map is stored in a form of a neural network that is formed by three layers including an input layer, an intermediate layer and an output layer. FIG. 7 shows a process concept in a neural network. The input layer has elements each corresponding to the direction and the magnitude of each LOF in the local areas. The output layer has elements that correspond to the alternative actions (for example, the direction and the speed, as generated by the action-generating section 18) which can be taken by the moving unit. FIG. 7 shows an exemplary case in which the direction of the moving unit is estimated. Directions that the moving unit may take such as left-turn, go-straight and right-turn are illustrated. When estimating the speed of the moving unit, the speed that the moving unit may take include low speed, intermediate speed and high speed, which are associated with the respective elements of the output layer. This state-action map has been prepared through a learning process with an error back-propagation algorithm in which the moving unit moves autonomously in a particular environment and the actual action commands are used as teacher's signals for the error back-propagation algorithm.

Referring back to FIG. 6, the estimated action at time t that is estimated from the LOFF using the state-action map is compared with the action command at the same time t to calculate a difference of action (S64). The term of “difference of action” refers to, for example, a difference in terms of direction and magnitude of the action. For example, in the neural network shown in FIG. 7, assuming that the respective outputs of the elements of turn-left, go-straight and turn-right are 0.7, 0.3 and 0.3, the estimated action becomes the turn-left. When the action command is turn-left, the difference between the outputs of the elements of turn-left, go-straight and turn-right and the values of 1, 0, 0 is calculated. Then, it is determined whether or not the calculated difference is equal to or smaller than a predetermined threshold value (S66). When the difference is equal to or smaller than the threshold value, it is determined that the LOFF does not include any part of the “figure” areas because the difference between the estimated action that is estimated from the LOFF and the actual action command is small. In this case, the process terminates here. When the difference is larger than the threshold value, the obtained difference of action is back-propagated from the output layer to the input layer in the neural network (S68). The result of this back-propagation in each element in the input layer represents the magnitude of contribution of each element to the afore-mentioned difference of action.

Now, the back-propagation method will be described.

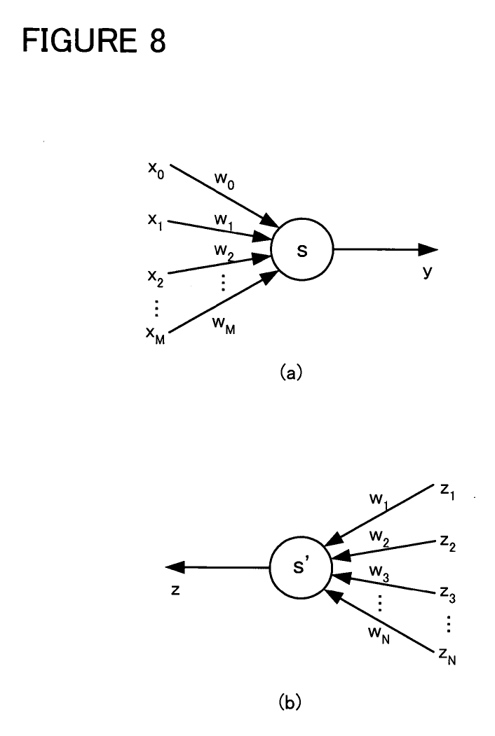

FIG. 8 is a schematic diagram for explaining an element (neuron) composing the neural network of the state-action map. FIG. 8(a) shows an element existing in the intermediate layer or the output layer when the action is estimated from the LOFF. FIG. 8 (b) shows an element existing in the intermediate layer or the output layer when the difference between the estimated action and the action command is back-propagated. Here, it is assumed that both elements are located in the intermediate layer.

The element of FIG. 8(a) is connected to elements 1 to M in the input layer with weights w₁ to w_{M} (the input x₀ is a threshold value of the Sigmoid function). The magnitude and the direction of the LOFF are input to the input layer and reach the output layer through the intermediate layer. The output y of the element in the output layer is calculated according to the following equation:

$$s = {\sum }_{n = 0}^{M} {w}_{i} {x}_{i}$$

$$y = \text{sigmoid(s)}$$

where “s” represents the state of the element in the intermediate layer, xᵢ represents the output of each element of the input layer, “sigmoid” represents the Sigmoid function.

The element of FIG. 8 (b) is connected to elements 1 to N in the output layer with weights w₁ to w_{N}. The difference between the estimated action and the action command is input in the output layer, and it is propagated back to the intermediate layer. The intermediate layer obtains “z” according to the following equation and propagates it back to the input layer.

$${s}^{′} = {\sum }_{n = 0}^{N} {w}_{i} {z}_{i}$$

$$z = α \times y \times {s}^{′}$$

where “s′” represents the state of the element in the intermediate layer, zᵢ represents a back-propagation output of each element of the output layer, z represents a back-propagation output of the element in the intermediate layer, and α represents a gain of the Sigmoid function.

In the above equations, the evaluation values of the error back-propagation method are modified. Since they are not used for the learning, the terms for assuring the convergence are not needed. According to these equations, the space distribution of the stimulus that contributes to the generation of the difference of action is reversely calculated. For each step-back in layer, the weighted contribution of the error that generates in the upper layer is calculated in the lower layer. In other words, the error that has actually generated in the upper layer and the activity degree of the concerned element in the lower layer are multiplied to the connection weight, so that the error contribution for that element is obtained. According to the same manner, the back-propagation is applied sequentially to the further lower layers.

Referring back to FIG. 6, the figure-ground estimating section 22 performs a figure-ground segregating process upon the LOFF using the result of the back-propagation in order to obtain the LOFF of the ground areas (S70). More specifically, the direction and the magnitude of each LOF are multiplied by the value that is back-propagated to the corresponding element in the input layer. Then, when both or either of the direction and the magnitude exceeds a predetermined threshold value, the concerned LOF is extracted. The magnitude and the direction of the extracted LOFF are made to be zero and such LOFF is regarded as a “LOFF of the ground” (FIG. 7).

Subsequently, the figure-ground estimating section 22 uses the calculated LOFF of the ground to perform the action estimating process (S74) and the action comparing process (S76) so as to determine whether or not the obtained difference is equal or smaller than the predetermined value (S78). These steps are performed similarly as in the above-described first run. When the difference of the actions exceeds the threshold value, the error back-propagation (S87), the figure-ground segregation (S88) and the calculation of the LOFF of the ground (S89) are performed again similarly as in the first run and the process returns to step S74. This iterative loop continues until the difference of action obtained in the action comparing process (S76) becomes smaller that the threshold value. Alternatively, an upper limit of the number of the iterative loops may be predetermined.

The figure-ground estimating section 22 calculates a proportion of the LOFF of the ground (that has been obtained until the last loop) relative to the whole image areas (S80) and determines whether or not this proportion is equal to or smaller than a predetermined threshold value (S82). Then, when the proportion of the LOFF of the ground exceeds the threshold value, the figure-ground estimating section 22 obtains the figure areas by removing all local areas which have been segregated as the LOFF of the ground areas until the last loop from the whole image areas and outputs the obtained figure areas to the object presence/absence determining section 24 (S84). When the proportion of the LOFF of the ground areas is equal to or smaller than the threshold value, it is determined that some abnormality may occur in the autonomously-moving unit itself or in the surrounding environment. This determination of the abnormality is informed to the action generating section 18 (S86).

The relatively large proportion of the segregated figure areas indicates that some abnormality occurs in the course of the processes from the measurement of the surrounding environment by the autonomously-moving unit, through the performance of the action, up to the estimation of the action because the action estimation for the autonomously-moving unit is not correctly performed, or that there is a high possibility that the autonomously-moving unit may stand in such environment that is not recognized by the moving unit (that is, the corresponding relation for that environment is not learned in the state-action map). In such case, the situation is informed as an “abnormality” to the action generating section 18 because it is difficult for the autonomously-moving unit to take an appropriate action. In response, the action generating section 18 issues an appropriate command (for example, stop the moving unit).

There are several cases that can be regarded as a cause for the occurrence of the abnormality: for example, when the action command issued by the action generating section 18 and the action taken actually by the autonomously-moving unit are different (for example, when the autonomously-moving unit falls down and/or when the moving unit cannot take any action due to some obstacle), when the imaging device fails, or when the autonomously-moving unit stays in such space that is not learned.

In summary, the figure-ground estimating section 22 receives the LOFF from the local area image processor 16 and the action command from the action generating section 18. Then, the figure-ground estimating section 22 performs iteratively the action estimating process, the action comparing process and the figure-ground segregating process, and determines the abnormality based on the finally-obtained LOFF of the ground areas and outputs the figure areas to the object presence/absence determining section 24 when there is no abnormality.

According to this embodiment, by verifying consistency between the estimated action and the actual action command, an occurrence of any abnormality can be detected in a series of processes in which the action of the autonomously-moving unit is first decided and performed, the environment where the moving unit itself stays is captured by the sensor, the action taken by the moving unit is recognized based on the captured information, and the recognized action and the decided action are compared. Accordingly, a blind movement of the autonomously-moving unit can be prevented.

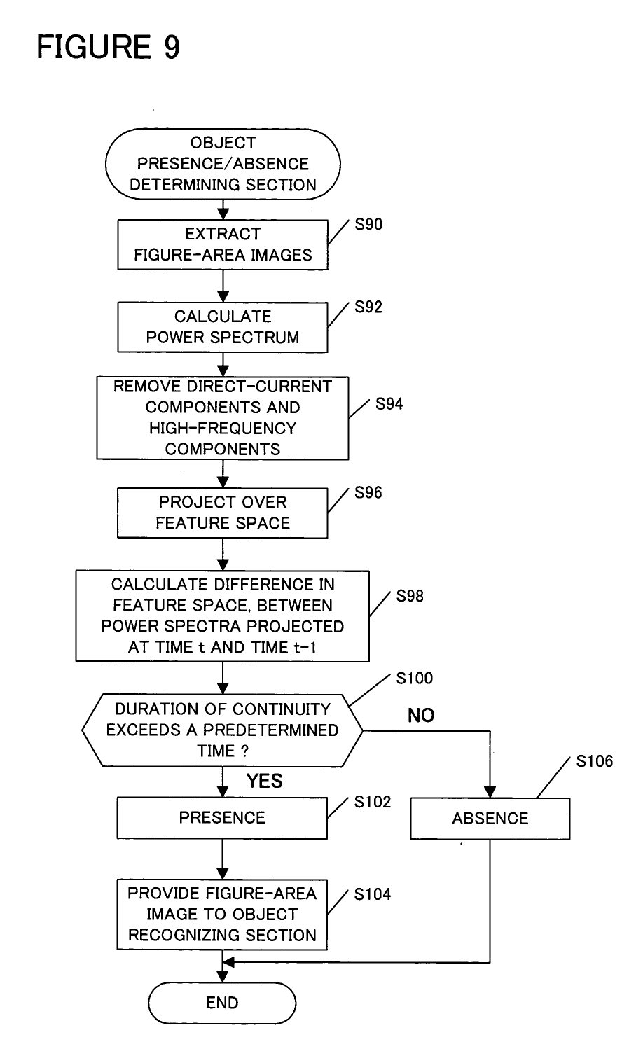

Now, a process in the object presence/absence determining section 24 will be described with reference to FIG. 9. According to the following flow, the object presence/absence determining section 24 determines whether or not an object actually exists within the local areas which are estimated as the “figure” areas by the figure-ground estimating section 22.

At first, the object presence/absence determining section 24 extracts the image corresponding to the position of the local areas estimated as figure areas by the figure-ground estimating section 22 from the image at time t which is input by the sequential image output section 14 (S90).

Next, the section 24 calculates the power spectrum of the figure area image using a common frequency analysis method such as the FFT or the filter bank (S92) and removes the high-frequency components and the direct-current components from the power spectrum so as to remain only the low-frequency components (S94). Then, the section 24 projects the obtained low-frequency components of the power spectrum over a feature space (S96).

The feature space is a space of the same dimension as the order of the power spectrum. Alternatively, the feature space may be prepared by performing a principal component analysis upon the power spectrum of the image included in the object pattern database 28. In this alternative case, the image in the database has a fixed size. When the figure area image is larger than the image in the database at the time of the projection over the feature space, the frequency resolution of the power spectrum is transformed to the resolution of the image of the database. When the figure area image is smaller than the image in the database, a zero interpolation is performed upon the figure area image so as to make its size equal to that of the fixed image of the database.

Subsequently, the object presence/absence determining section 24 calculates a distance in the feature space between the current (time t) power spectrum projected over the feature space and the power spectrum projected at time t−1 (S98). When the distance is smaller than a predetermined threshold value, it is determined that “a continuity exists”

This process is performed sequentially, and when the existence of the continuity between the vectors of the power spectra at time t and at time t−1 is determined consecutively over a predetermined time period, it is determined that an object actually exists in the figure area image (S102) and that feature area image is output to the object recognizing section (S104). When the time period of the consecutive determination for the existence of the continuity is equal to or smaller than the predetermined one, it is determined that no object exists in the figure area image (S106).

This determination of the continuity is made based on the following reasoning: although there is a possibility that the figure area detected from the image that is captured at a certain time may be a noise, there is a high possibility that an object actually exists in the image when the similar figure areas are detected continuously over a certain time period. However, when the images in the figure areas themselves are compared, determination of continuity may be difficult because the size and/or the angle of the captured object may change due to the action of the autonomously-moving unit during that time period.

However, when the moving distance is relatively short, such change appears as a change in a position of the object within the detected figure area image. In such case, when a frequency conversion is performed on that figure area image, almost no change is observed in the frequency during the moving time period but only the change of the phase appears. In other words, there is a characteristic that during a short time period, the spatial phase of the figure area image may change but the spatial frequency changes very little. In the present embodiment, therefore, in order to determine the continuity, the power spectrum is calculated to remove the phase information of the figure area image (in other words, the positional change of the object in the image due to the time elapse) and further remove the noisy high-frequency elements and the unnecessary direct-current elements so as to obtain only the low-frequency elements, an expression with no translational change.

It should be noted that the time period for determining the continuity must be set to a time period during which the size and/or the angle of the object to be captured may not change considering the speed of the action of the autonomously-moving unit.

Finally, the object recognizing section 26 will be now described. The object recognizing section 26 extends the figure area image over the feature space and refers to the object pattern database 28 to recognize the object in the figure area image inputted by the object presence/absence determining section 24.

Fixed forms of images for objects to be recognized are pre-stored in the pattern database 28. Additionally or alternatively, the figure area images that are inputted by the object presence/absence determining section 24 can be accumulated while the moving unit moves autonomously. The object recognizing section 26 compares the figure area image with the images in the databases 28 to recognize the object. As a comparison method, a known pattern recognition method, a maximum likelihood method, a neural network method or the like may be used.

When it is determined there is no image corresponding to the figure area image in the database 28, that figure area image may be accumulated in the database 28. When the size of the figure area image is larger than that of the fixed form of the image, a down-sampling is performed and when it is smaller, a zero interpolation is performed, so that the size of the figure area image is transformed to that of the fixed form of the image.

Although the present invention has been described with reference to the specific embodiment, the invention is not limited to such embodiment.

1. An object detection apparatus for detecting an object based on input images that are captured sequentially in time by a moving unit, comprising:
an action generating section for generating an action command to be sent to the moving unit;
a local image processor for calculating flow information for each local area in the input image;
a figure-ground estimating section for estimating an action of the moving unit based on the flow information, calculating a difference between the estimated action and the action command and then determining a certain local area as a figure area when such difference in association with that specific local area exhibits an error larger than a predetermined value,; and
an object presence/absence determining section for determining presence/absence of an object in the figure area.

2. The object detection apparatus as claimed in claim 1, further comprising an object recognizing section for recognizing an object when it is determined that an object exists in the figure area.

3. The object detection apparatus as claimed in claim 1, wherein the figure-ground estimating section estimates the action of the moving unit by utilizing learning results of the relation between the flow information for each local area and the action of the moving unit.

4. The object detection apparatus as claimed in claim 3, wherein the flow information fro each local area and the action of the moving unit is related through a neural network.

5. The object detection apparatus as claimed in claim 4, wherein the figure-ground estimating section propagates back the difference between the estimated action and the action command by using an error back-propagation algorithm so as to determine the local area that causes the error.

6. The object detection apparatus as claimed in claim 5, wherein the figure-ground estimating section determines that an abnormality occurs in the moving unit or in the environment surrounding the moving unit when an extent occupied by the figure areas causing the error exceeds a predetermined threshold value.

7. The object detection apparatus as claimed in claim 5, wherein the figure-ground estimating section removes the areas causing the difference between the estimated action and the action command from the flow information for each local area and estimates again an action of the moving unit from the remaining flow information.

8. The object detection apparatus as claimed in claim 1, wherein the object presence/absence determining section compares frequency elements of sequential images in the figure areas each other after removing the high-frequency elements from those frequency elements so as to determine presence or absence of continuity which is a measurement for evaluating succession of an object in the images and then determines that an object is included in the figure areas when the presence of the continuity is determined.

9. An object detection method, wherein frequency elements of sequentially-captured images after removing the high-frequency elements from those frequency elements are compared each other to determine presence or absence of continuity which is a measurement for evaluating succession of an object in the images and then it is determined that the same object is included in the images when the presence of the continuity is determined.

10. An object detection method for detecting an object based on input images that are captured sequentially in time by a moving unit, including steps of:
generating and sending an action command to the moving unit;
calculating flow information for each local area in the input image;
estimating an action of the moving unit based on the flow information;
comparing the estimated action with the action command to calculate a difference between them;
determining a specific local area as a figure area when such difference in association with that specific local area exhibits an error larger than a predetermined value; and
determining presence/absence of an object in the figure area.

11. The object detection method as claimed in claim 10, further including a step of recognizing an object when it is determined that an object exists in the figure area.

12. The object detection method as claimed in claim 10, further including a step of estimating the action of the moving unit based on learning results of the relation between the flow information for each local area and the action of the moving unit.

13. The object detection method as claimed in claim 12, wherein the flow information fro each local area and the action of the moving unit is related through a neural network.

14. The object detection method as claimed in claim 13, wherein the difference between the estimated action and the action command is propagated back by using an error back-propagation algorithm so that the local area causing the error is determined.

15. The object detection method as claimed in claim 10, wherein it is determined that an abnormality occurs in the moving unit or in the environment surrounding the moving unit when an extent occupied by the figure areas causing the error exceeds a predetermined threshold value.

16. The object detection method as claimed in claim 10, further including a step of removing the areas causing the difference between the estimated action and the action command from the flow information for each local area and estimating again an action of the moving unit from the remaining flow information.

17. A computer program product for an object detection apparatus including a computer for detecting an object based on input images that are captured sequentially in time by a moving unit, said program when executed performing the functions of:
generating and sending an action command to the moving unit;
calculating flow information for each local area in the input image;
estimating an action of the moving unit based on the flow information;
comparing the estimated action with the action command to calculate a difference between them;
determining a specific local area as a figure area when such difference in association with that specific local area exhibits an error larger than a predetermined value; and
determining presence/absence of an object in the figure area.

18. The computer program product as claimed in claim 17, further performing the function of recognizing an object when it is determined that an object exists in the figure area.

19. The computer program product as claimed in claim 17, further performing the function of estimating the action of the moving unit utilizing learning results of the relation between the flow information for each local area and the action of the moving unit.

20. The computer program product as claimed in claim 19, wherein the flow information fro each local area and the action of the moving unit is related through a neural network.
